(19) United States
(12) Patent Application Publication
(10) Pub. No.: US 2009/0015463 A1
(43) Pub. Date: Jan. 15, 2009

(54) Monopulse Radar System for Motor Vehicles

(75) Inventors: Maximilian Tschernitz, Freising (DE); Thomas Zwick, Graben-Neudorf (DE)

Correspondence Address: LERNER GREENBERG STEMER LLP, P O BOX 2480, HOLLYWOOD, FL, 33022-2480, US

(73) Assignee: CONTINENTAL AUTOMOTIVE GmbH, Hannover (DE)

(21) Appl. No.: 12/067,463

(22) PCT Filed: Sep. 20, 2006
(86) PCT No.: PCT/EP2006/066517

§ 371 Date: Sep. 24, 2008

(30) Foreign Application Priority Data
Sep. 20, 2005 (DE) 10 2005 044 884.4

(51) Int. Cl. G01S 13/48

(52) U.S. Cl. 342/146

(57) ABSTRACT

A radar system for measuring the angular position of a remote object has an antenna which is provided with at least two receiving antennae, a transmitter connected to the antenna for transmitting a transmitted signal, a first receiver connected to the first reception antenna for receiving the transmitted signal reflected by the remote object in the form of a first received signal, and a second receiver connected to the second reception antenna for receiving the transmitted signal reflected by the remote object in the form of a second received signal. The first receiver is provided with a first element for determining the first phase of the first received signal and the second receiver is provided with a second element for determining the second phase of the second received signal.

The invention relates to a method and a device in accordance with the preamble of claim 1.

Radar systems typically measure the distance and/or speed of remote objects. In many cases, additional information regarding the position of the remote object, especially its angular position (e.g. an angular deviation from a reference direction), is useful.

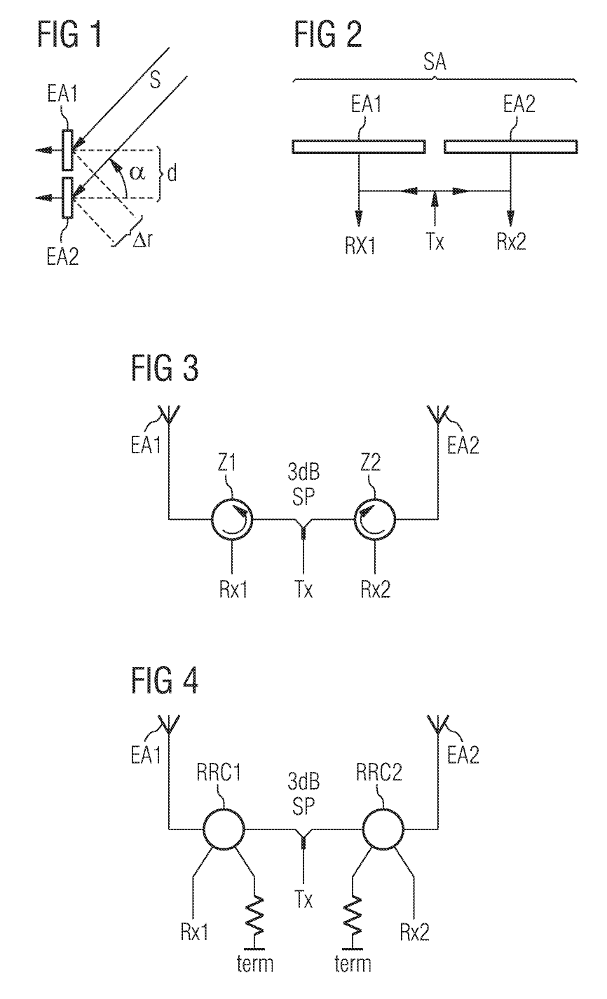

One possible way of determining the angular position of a remote object is to use two receiving antennas EA1, EA2, which are located a distance d from each other, as shown in FIG. 1.

For example, the angular position α of an object can be calculated from the phase difference of two signals S that have been received from two receiving antennas EA1, EA2, by

$$α = arcsin \frac{ϕ \cdot λ}{2 π \cdot d} ,$$

with φ as the phase difference at the position of both receiving antennas EA1, EA2 being a signal reflected from the remote object. This method is normally known as the phase-monopulse method.

A difficultly with this is distinguishing between objects which are at the same distance but at a different angular position relative to the radar system. By using more than two receiving antennas and by means of digital beam forming, it is possible to not only achieve an angular measurement but also a bearing discrimination. Targets with different angular positions but at the same distance can be distinguished in this way.

In many applications, for example for road vehicles, radar systems are necessary which generate a radar beam with a small angle of aperture (e.g. of only a few degrees). Because with radar it is always assumed that the transmitted signal is reflected at one point and therefore received again from the same direction in which it has been transmitted, the product of the transmission and reception directivity characteristic (two-way characteristic) is used to characterize the coverage. The angle of aperture of an antenna is in principle directly dependent on the size of the aperture of the antenna, i.e. narrow beams require a large antenna aperture.

There is often a requirement for the smallest possible radar systems with the smallest possible antenna areas at the same time. This is, for example, the case with radar systems for road vehicles, which have to locate other vehicles during the journey, in order to warn the vehicle driver of a possible danger of collision. A reason for this is the limited availability of space on the vehicle, which must also allow room for other systems. A small radar system for measuring the angular position of a remote object is enabled by simultaneous use of receiving antennas EA1, EA2 as a transmitting antenna A, as shown in FIG. 2.

A further difficulty for a phase-monopulse system can be the area of ambiguity of the angular position. A phase shift of an angular position is uniquely assigned within the area of unambiguity. In a case of a phase-monopulse receiver with a main beam direction vertical to the axis through both receivers, the area of unambiguity lies between

$${α}_{min} = arcsin \frac{λ}{2 \cdot d}$$

$$and$$

$${α}_{max} = arcsin \frac{λ}{2 \cdot d} .$$

Because the accuracy of the angular measurement is better if there is a greater distance between the phase-monopulse receiving antennas, distances greater than λ/2 are chosen for radar systems with narrow angles of aperture. This of course also means that the area of unambiguity is less than 180° and therefore it must be ensured by means of the directivity diagram (two-way) that no incorrect angular measurements occur. In order to avoid incorrect measurements of the angular position α, it must be guaranteed that the receiving antennas do not register signals from the area of ambiguity. To do this, the product of the transmitting and receiving characteristic (two-way) must have the following characteristics.
The angle of aperture of the main beam must be sufficiently narrow
The side-lobe suppression must be sufficiently large.

The suppression (relative to antenna gain in the main beam direction) outside the area of unambiguity must be greater than the dynamic range required by the system. In road traffic, the dynamic range is, for example, due to the difference in backscatter between an extremely large target (such as a truck) and an extremely small target (such as a motor cycle or pedestrian).

The unambiguity area is greater the smaller the distance between the receiving antennas, which is in contrast to the requirement for a small angle of aperture of the beam required by large-area antennas. To use the receiving antennas as a transmitting antenna at the same time, the distance between the receiving antenna and transmitting antenna is linked. The distance between the receiving antennas can not therefore be independently chosen i.e. the unambiguity area and angle of aperture cannot be separately optimized.

EP 0 713 581 B1and DE 694 33 113 T2 describe a vehicle radar system for determining the deviation of a target object relative to a reference azimuth. In this case, an antenna with a pair of lobes is used for sending transmitted signals. The purpose of the lobes is to send a transmitted signal with a phase difference and to detect two doppler signals at two spatially separate positions. An aggregate signal and a differential signal are formed from the two doppler signals. The deviation relative to the reference azimuth is determined by comparing the aggregate and differential signals, by forming a quotient in both lobes. The doppler signals are superimposed to determine the aggregate and differential signals. A disadvantage of this solution is that the amplitudes of the received doppler signals are usually exposed to substantial fluctuations in the lobes. This is due on one hand to the different paths that have been traveled and on the other hand also to fluctuations which can occur between the lobes, e.g. due to different temperatures.

The object of this invention is therefore to reliably determine the angular position of a remote object.

This object is achieved by the measures given in claim 1. Advantageous embodiments of the invention are given in further claims.

The invention relates to a radar system for measuring the angular position of a remote object, comprising
an antenna with at least two receiving antennas;
a transmitter which is connected to the antenna for the transmission of a transmitted signal;
a first receiver, which is connected to a first of the at least two receiving antennas for receiving a transmitted signal reflected from the remote object, as a first received signal;
a second receiver, which is connected to a second of the at least two receiving antennas for receiving a transmitted signal reflected from the remote object, as a second received signal.

In that
the first receiver includes a first means for determining a first phase of the first received signal and
the second receiver has a second means for determining a second phase of the second received signal, the angular position of a remote object can be reliably determined.

Fluctuations in the amplitude have no effect on the determination of the phase difference of the received signals, especially for a radar system according to the invention. To determine the phase difference of the first phase and of the second phase, the radar system can, for example, have a microcontroller connected to the receivers. The angular position can also be determined in the microcontroller by using the phase difference. As an alternative to digital circuits such as microcontrollers, analog circuits with operational amplifiers can, for example, also be used.

The following advantages can also additionally result:

In that,

the first receiver and/or the second receiver is an IQ receiver,

the phase of received signals can be directly and easily measured. An IQ receiver consists of two mixers in which the input signal is mixed with the local oscillator signal in the baseband. In one of the two mixers, the local oscillator signal in this case has a 90° phase shift. This enables complex baseband signals, i.e. amount and phase, to be measured. IQ receivers can be used in all radar systems but are used particularly in pulse radar systems.

In that,

the first receiver and/or the second receiver includes a mixer and the radar operates on the continuous wave (CW) or frequency modulator continuous wave (FMCW) principle, the phase of the received signals can be directly and easily measured after a Fourier transformation of the received signals.

The receiver can also be designed as an IF sampling receiver. With an IF sampling receiver, the received signal is sampled at an intermediate frequency. This means that the wanted signal including the carrier signal and therefore the phase, are present in the microcontroller. In that the first receiver and/or the second receiver is an IF sampling receiver, the phase of the received signals can be directly measured.

In that,

the antenna includes an even number of similar receiving antennas,

all the receiving antennas can have an identical directivity characteristic with an optimized directivity of transmission characteristic at the same time.

In that,

the radar system includes a control means, which controls the antenna in such a way that a directivity characteristic optimized for the transmitted signal or for the combined transmitted-received signal results,

the side lobes can be substantially reduced, which enables incorrect measurements of the angular position to be avoided.

In that,

the antenna is arranged on a side of a circuit board and the control means includes conductor tracks and splitters,

a control means, which can be implemented particularly easily and cost-effectively, with a high service life results.

In that,

the antenna includes an array of patches and that a receiving antenna includes a patch or a part array of the array,

a radar system that can be produced particularly easily and cost-effectively results.

In that,

the array includes a linear array and an aperture coverage of the linear array in a central area of the array has a pronounced amplitude maximum,

a directed radiation of the transmitted signal can result, which has a high side-lobe suppression.

In that,

transmitted signals with a frequency of more than 20 GHz can be generated by the radar system,

radar systems of a size suitable for road vehicles can be produced.

For more than two receiving antennas, phase differences, for example in pairs, between the receivers can be determined. More reliable information on the angular position can be obtained in this way. In particular, if there are several remote objects within the range of the radar sensor, false angular positions of remote objects, or the absence of remote objects, can be rejected, for example by using statistical methods.

In that the antenna includes more than two receiving antennas to each of which a receiver with a means for determining a phase of a received signal is connected, it is possible to not only achieve an angular measurement but also a bearing discrimination. This means that a discrimination can be made between several objects with different angles but at the same distance.

The invention is explained in more detail in the following by means of examples and drawings. The drawings are as follows:

FIG. 1 Arrangement for determining the angular position of a remote object by using two receiving antennas;

FIG. 2 Arrangement for determining the angular position of a remote object using an antenna designed as a transmitting antenna, which includes two receiving antennas;

FIG. 3 A block diagram of an inventive radar system;

FIG. 4 A block diagram of an inventive radar system;

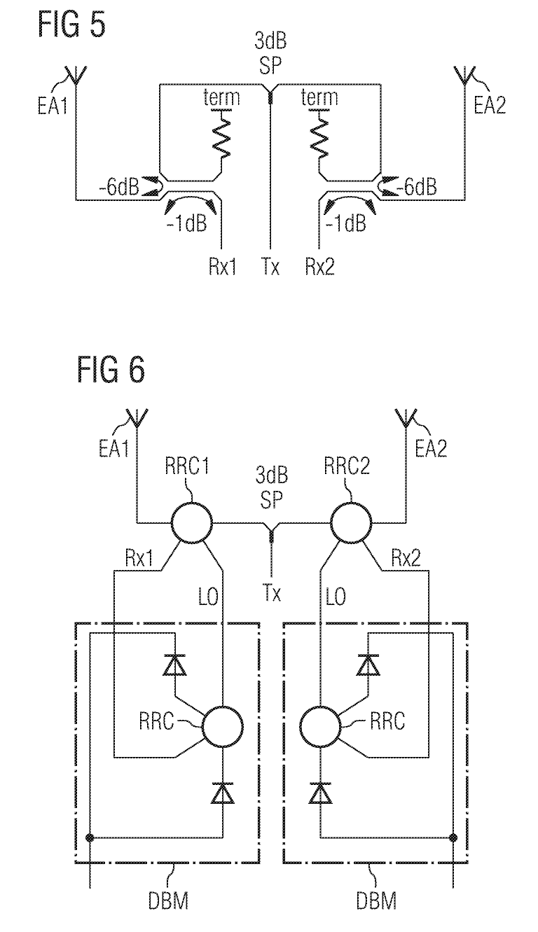

FIG. 5 A block diagram of an inventive radar system;

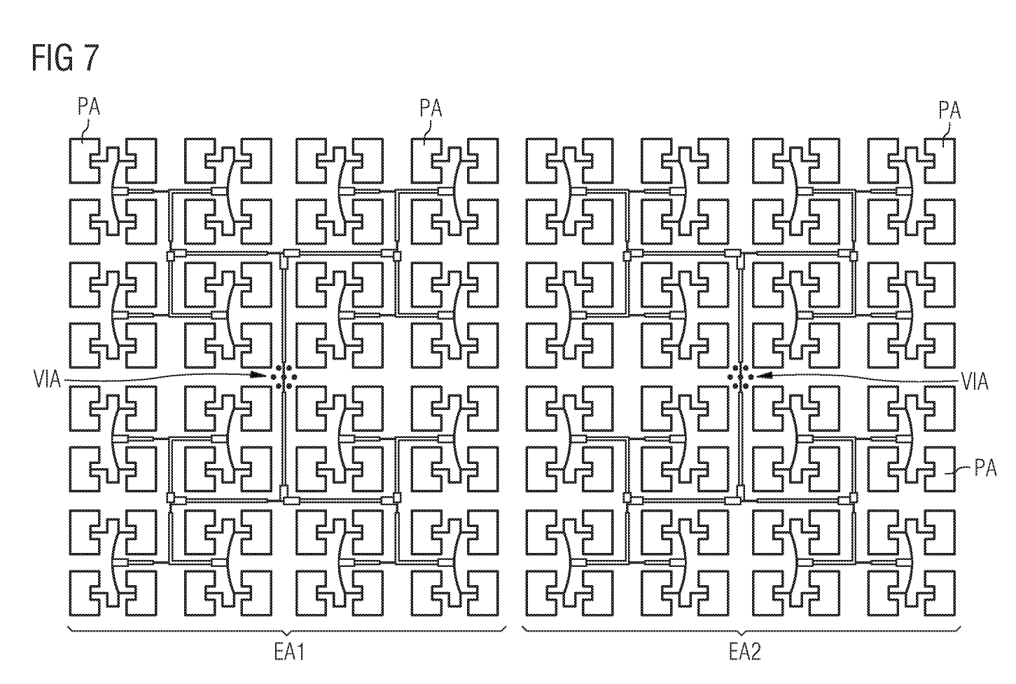

FIG. 6 A block diagram of an inventive radar system;

FIG. 7 Antenna arrangement with patches on the front of a circuit board of an inventive radar system;

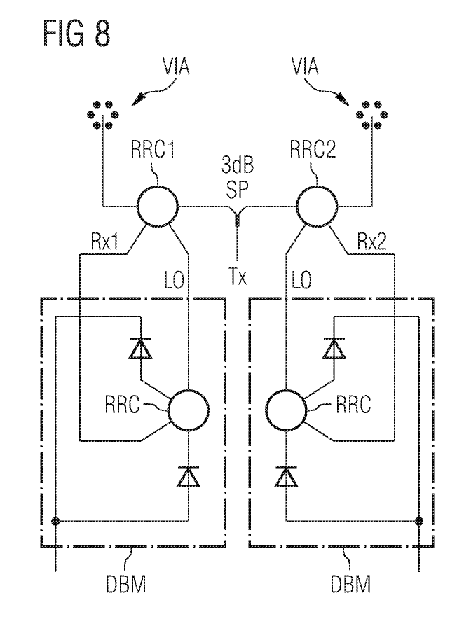

FIG. 8 A circuit arrangement on the back of a circuit board of an inventive radar system;

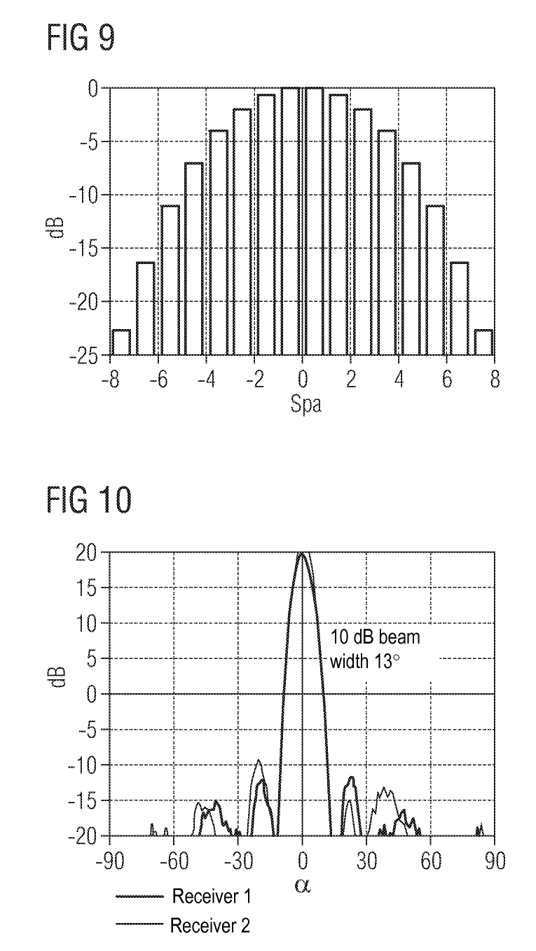

FIG. 9 Aperture coverage for a further embodiment of the antenna arrangement shown in FIG. 7;

FIG. 10 Transmitting-receiving directivity diagrams for the receiving antennas of the radar system described in FIGS. 7-9;

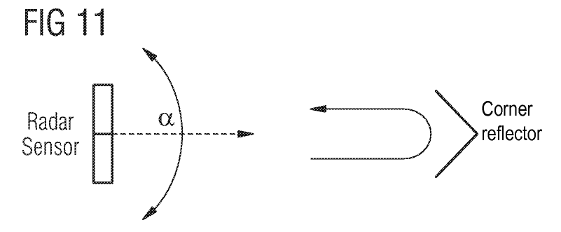

FIG. 11 Measuring arrangement for determining the directivity characteristics of a radar system;

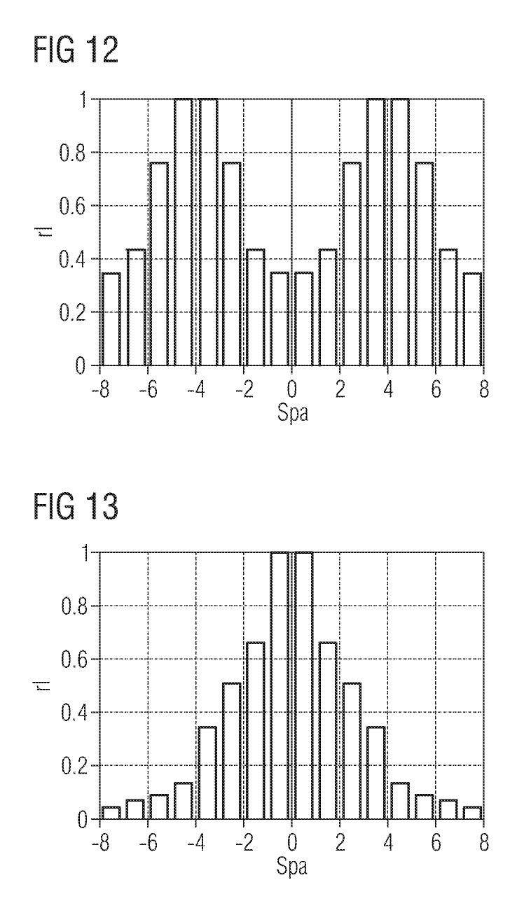

FIG. 12 Aperture coverage of a first simulated radar system;

FIG. 13 Aperture coverage of a second simulated radar system;

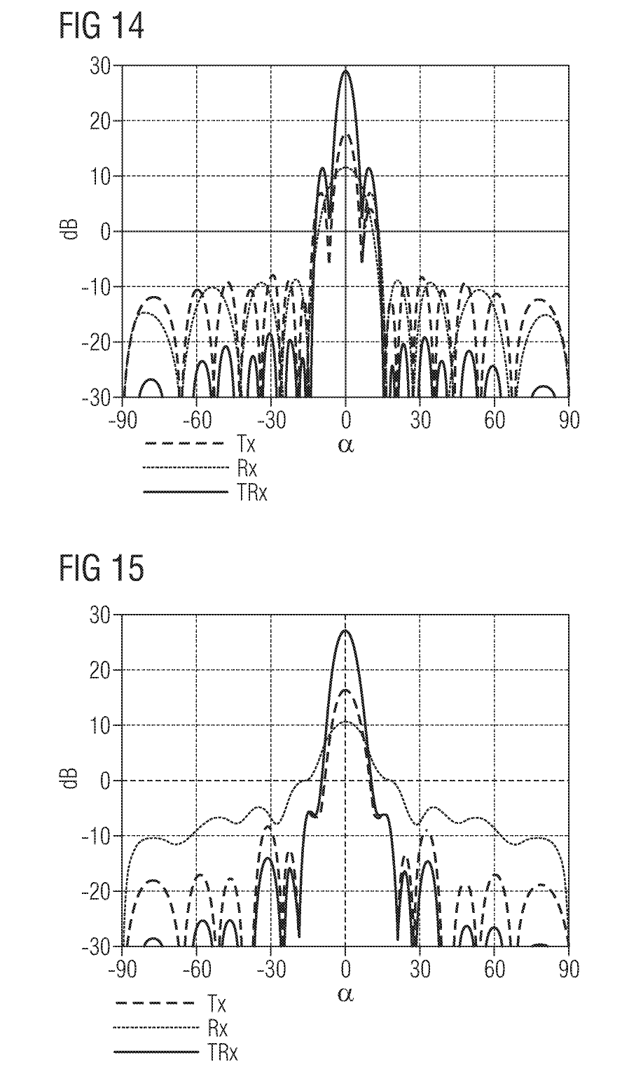

FIG. 14 Directivity characteristics of the first simulated radar system;

FIG. 15 Directivity characteristics of the second simulated radar system;

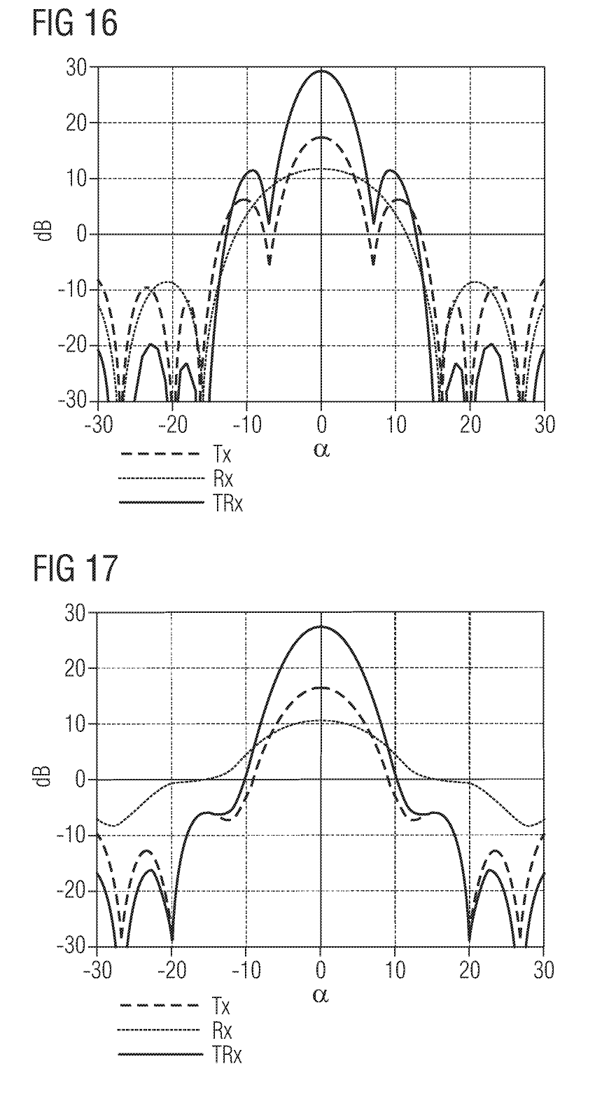

FIG. 16 Enlarged section of the directivity characteristics of the first simulated radar system;

FIG. 17 Enlarged section of the directivity characteristics of the second simulated radar system;

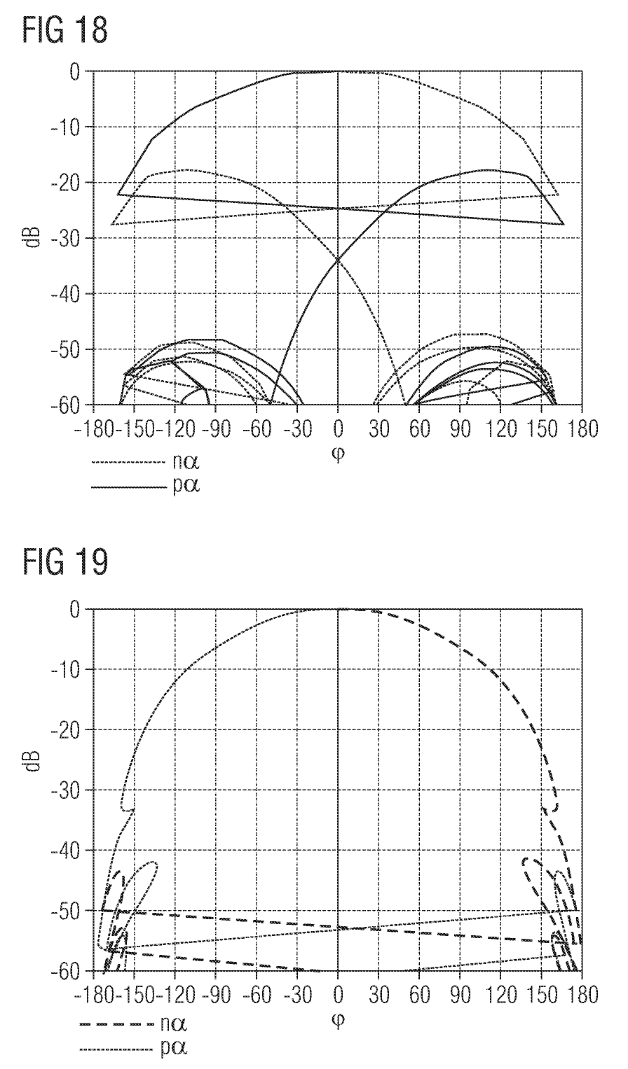

FIG. 18 Unambiguity diagram of the first simulated radar system;

FIG. 19 Unambiguity diagram of the second simulated radar system.

FIGS. 3-6 show circuit arrangements which are suitable for separating the received signals and the transmitted signal.

FIG. 3 shows a block diagram of a radar system in a first exemplary embodiment. An antenna A includes two receiving antennas EA1, EA2. In a preferred embodiment, the two receiving antennas EA1, EA2 are designed as patch arrays. A transmitter Tx is connected via a splitter SP to two receiving antennas EA1, EA2 so that a transmitted signal can be transmitted via both receiving antennas, EA1, EA2. In this example, a symmetrical three 3 dB splitter SP is used to split the transmitted signal. A first IQ receiver Rx1 is connected to a first of the two receiving antennas EA1 to receive the transmitted signal reflected from a remote object, as a first received signal. To separate the transmitted signal from the first received signal, the first IQ receiver Rx1, the transmitter Tx and the first receiving antenna EA1 are each connected to a terminal of a circulator Z1. A second IQ receiver Rx2 is connected to the second receiving antenna EA2 to receive the transmitted signal reflected from the remote object, as a second received signal. In order to separate the transmitted signal from the second received signal, the second IQ receiver Rx2, the transmitter Tx and the second receiving antenna EA2 are each connected to a terminal of the second circulator Z2. The phases of the received signals can be determined directly at a fixed timepoint by both IQ receivers Rx1, Rx2. To determine an angular position of the remote object, the two receivers Rx1, Rx2 can, for example, be connected to a microcontroller, which calculates the phase difference and from this determines the angular position α.

Thanks to the use of circulators Z1, Z2, the radar system shown in FIG. 3 enables an optimum signal-to-noise ratio and a loss-free separation of the transmitted signal and received signals.

FIG. 4 shows a block diagram of a second exemplary embodiment of a radar system. The circuit is the same as the circuit shown in FIG. 3, except for the circulators. Instead of the two circulators, two rat-race couplers RRC1, RRC2 are used. The solution based on rat-race couplers is more cost-effective that the solution based on circulators but half of the transmitting power of the transmitter Tx is terminated in the terminating term of the rat-race couplers RRC1, RRC2. This disadvantage can, however, be compensated for by an increased transmission power of the transmitter Tx and therefore does not have a negative influence on the dynamic range. A 3 dB loss also results in the receiver path due to the rat-race concept. In typical automobile radar systems, this therefore results in an increased signal-to-noise ratio. To compensate for the reduced signal-to-noise ratio the rat-race couplers RRC1, RRC2 can be replaced by standard couplers with a non-symmetrical coupling. FIG. 5 shows a corresponding block diagram. This shifts part of the loss from the receiver path to the transmitter path.

Because non-ideal circulators, as shown in the exemplary embodiment in FIG. 3, also have an insertion loss, the third exemplary embodiment shown in FIG. 5 is comparable with regard to receiver sensitivity with the concept in FIG. 3, which is optimum with regard to the signal-to-noise ratio.

Instead of dissipating half of the transmission power in the terminating term in FIGS. 4 and 5, these connections can also be used as local oscillators LO for the receiver mixers, as in a fourth exemplary embodiment, shown in FIG. 6, with double-balanced mixers DBM. In this exemplary embodiment, a double-balanced mixer DBM is realized by means of a further rat-race coupler RRC and two diodes.

FIGS. 7 to 11 show an exemplary embodiment:

FIG. 7 shows a front, and FIG. 8 a back, of a printed circuit board. An 8×16 array of 8×16 patches designed as an antenna is arranged on the front. The 8×16 array serves as a transmitting antenna and is divided into two 8×8 arrays, which serve as receiving antennas EA1, EA2. An HF circuit, essentially the same as the HF circuit shown in FIG. 6, is arranged on the back. The antennas on the front and the HF circuit on the back are connected to each other by vias VIA.

The transmitting antenna in FIG. 7 has a 120 mm×60 mm aperture, in order to achieve a narrow horizontal and vertical angle of aperture. The individual patches PA are connected in a circuit, which includes conductor tracks and splitters, in such a way that an optimum total directivity diagram is achieved due to an optimized control.

FIG. 9 shows an optimized control of the 8×16 array of the antenna arrangement (aperture coverage in relative power in dB), shown in FIG. 7, in the plane through the two centerpoints of the transmitting antennas EA1, EA2. In this case, the antenna gaps with the negative index belong to EA1 and those with the positive index to EA2. Both transmitting antennas are controlled as a symmetrical mirror image. The phases of all patches are identical. This enables a vertical radiation to be achieved, The outer gaps have a lower aperture coverage than the gaps in the center. An optimized directivity diagram with regard to the angle of aperture and the side-lobe suppression can be achieved in this way.

FIG. 10 shows a measured two-way directivity diagram (product of a transmitter directivity diagram with the respective receiver directivity diagram) of the radar system, described in FIGS. 7-9, for the two receiving antennas, EA1, EA2 designed as an 8×8 array. The complete antenna assembly, i.e. the antenna, shown in FIG. 7 and designed as a 16×8 patch array, with the aperture coverage shown in FIG. 9, serves as the transmitting antenna. The two 8×8 patch arrays serve as receiving antennas EA1, EA2. In this case, the radar system was rotated about a rotary axis parallel to the gaps, as shown in FIG. 11, in order to achieve the angular position α in degrees shown in FIG. 1, with a corner reflector being used as a remote object for reflection of the transmitted signal.

The relative amplification in dB relative to the angular position α in degrees is shown in FIG. 10. With an aperture of 120 mm, very small side lobes, about 30 dB smaller than the main lobe, and an opening angle (10 dB beam width) of 12 degrees is achieved for the combined transmitting-receiving directivity diagram.

A radar system described in FIGS. 7-11 is suitable mainly for road vehicles. If a printed circuit board on which the patch antenna array is arranged is secured to the vehicle in such a way that the gaps Spa of the 8×16 array are arranged vertical to the surface of the earth, a radar system with a particularly suitably aligned directivity characteristic is obtained. The directivity diagram shown in FIG. 10 then lies in the horizontal.

Similar to the gaps Spat of a patch array, the amplitude distribution of the rows of the patch array can be optimized, in that the outer rows have a smaller aperture coverage than the inner rows of the array. In this way, an additional, increased side-lobe suppression can be achieved which is lower in unwanted directions.

FIGS. 12-19 show a simulation of a comparison of two radar systems with two receiving antennas. The simulations are based on the assumption of ideal linear arrays of point radiators. Both simulations are based on the same radar systems, with the exception of the aperture coverage. The receiving antennas each comprise 8 point radiators. The transmitting antenna (=antenna) comprises the two receiving antennas and is a regular linear array of 16 point radiators.

FIGS. 12, 14, 16 and 18 show a first radar system with which the two receiving antennas are individually provided with optimum control, in order to achieve an optimum directivity diagram with a large side-lobe suppression for the receiving antennas. FIGS. 13, 15, 17, 19 show a second radar system, which includes a control means which controls the antenna (=transmitting antenna) in such a way that a directivity characteristic with a large side-lobe suppression optimized for the transmitted signal results.

FIG. 12 shows the control of the point radiators of the first radar system in the form of the amplitude distribution of the complete 8×16 array over the 16 gaps Spa of the 8×16 array in relative power r1. FIG. 13 shows, in the same way, the control of the point radiators of the second radar system.

FIG. 14 shows a directivity characteristic of the first radar system and FIG. 15 shows the directivity characteristic of the second radar system, in each case for the transmitter Tx, the receiver Rx and the combined directivity characteristic TRx for the transmitter Tx and receiver Rx. FIG. 16 shows an enlarged section of the directivity characteristic from −30° to +30° of the first radar system. FIG. 17 shows the same section for the second radar system.

The directivity characteristic of the transmitting antenna has much smaller side lobes on the second radar system than on the first radar system, therefore the reception diagram is at first sight less optimal. The complete diagram (two-way), however, shows better characteristics for the second radar system. In the comparison, the second radar system has a suppression of the first side lobes of appreciably more than 30 dB compared with the main lobes, with the relative suppression of the first side lobes of the first radar system not even amounting to 20 dB.

The advantage of the second radar system compared with the first radar system becomes particularly clear when FIGS. 18 and 19 are compared. In the simulation, the remote object was rotated around an axis parallel to the gaps. In doing so, negative angular positions nα and positive angular positions pα were generated. In addition to the directivity characteristic, the phase difference φ of the signals at both receivers was determined relative to the angular position α. For the reflected signals, the relative reflected signal intensity in dB for the first radar system is shown compared with the phase difference φ of the reflected signals. FIG. 19 shows a representation similar to FIG. 18 for the second radar system.

For both radar systems, different angular positions α of the remote object can result in identical phase differences φ. If the reflected signals, however, have distinctly different signal intensities (difference greater than the required dynamic range) for the different angular positions α, the angular position α can nevertheless be clearly determined. A comparison of FIG. 18 with FIG. 19 clearly shows that, with a fixed phase shift, for the second radar system the difference between the strongest signal intensity and the second-strongest signal intensity is considerably higher. In a range of −120° to +120° for the phase shift, the difference for the first radar system is sometimes less than 20 dB. For the second radar system, the difference, essentially over the complete range of −120° to +120°, is more than 40 dB, which would be acceptable in a typical automobile radar. The second radar system is therefore essentially less susceptible to false angular measurements than the first radar system.

The advantages of a radar system which has a control means which controls the antenna in such a way that an optimized directivity characteristic results for the transmitted signal or for the combined transmitted-received signal, such as, for example, is the case for the radar system shown in FIGS. 13, 15, 17 and 19, are obtained for all radar systems, which comprise
an antenna with at least two receiving antennas;
a transmitter, which is connected to the antenna for the transmission of a transmitted signal;
a first receiver, which is connected to a first of the at least two receiving antennas for receiving a transmitted signal reflected from the remote object, as a first received signal;
a second receiver, which is connected to a second of the at least two receiving antennas for the reception of the transmitted signal reflected from the remote object, as a second received signal and
a means for determining a phase difference between the first received signal and the second received signal or a characteristic variable that can be uniquely assigned to the phase difference, by means of which the angular position of a remote object can be determined.

In a further embodiment, not to be regarded as representing a final one, the radar system can, for example, be designed as a CW or FMCW radar system, as a pulse radar system, as a pseudo-noise radar system or as a frequency shift keying radar system.

1-11. (canceled)

12. A radar system for measuring an angular position of a remote object, comprising:
an antenna having at least two receiving antennas, including a first receiving antenna and a second receiving antenna;
a transmitter connected to said antenna for transmitting a transmission signal;
a first receiver connected to said first receiving antenna for receiving a reflected transmission signal reflected from the remote object, as a first received signal, said first receiver having first means for determining a first phase of the first received signal; and
a second receiver connected to said second receiving antenna for receiving a reflected transmission signal reflected from the remote object, as a second received signal, said second receiver having second means for determining a second phase of the second received signal.

13. The radar system according to claim 12, wherein at least one of said first and second receivers includes a mixer and the radar system is configured for operation according to a frequency-modulated continuous wave principle.

14. The radar system according to claim 13, wherein said at least one receiver is an IF sampling receiver.

15. The radar system according to claim 12, wherein at least one of said first and second receivers is an IQ receiver.

16. The radar system according to claim 15, wherein said at least one receiver is an IF sampling receiver.

17. The radar system according to claim 12, which further comprises a control device configured to control said antenna with optimization of a directivity characteristic for the transmitted signal or for a transmitted-received signal combination of the transmitted-received signal.

18. The radar system according to claim 12, wherein said at least two receiving antennas of said antenna are an even number of receiving antennas.

19. The radar system according to claim 17, wherein said antenna is disposed on one side of a circuit board and said control device includes conductor tracks and splitters.

20. The radar system according to claim 12, wherein said antenna includes an array of patches and a respective said receiving antenna includes a patch or a partial array of said array.

21. The radar system according to claim 20, wherein said array includes a linear array and an aperture coverage of said linear array, on an axis through said receiver centerpoints in a central area of said array, has a pronounced amplitude maximum.

22. The radar system according to claim 12, configured to generated transmission signals having a frequency of more than 20 GHz.

23. The radar system according to claim 12, wherein said antenna includes more than two said receiving antennas, and each of said more than two receiving antennas has a receiver with means for determining a phase of a respectively received signal connected thereto.
